(19) United States
(12) Patent Application Publication
(10) Pub. No.: US 2024/0232570 A9
(43) Pub. Date: Jul. 11, 2024

(54) METHOD AND SYSTEM FOR PREDICTING HEIGHT OF CONFINED WATER RISING ZONE

(71) Applicant: Shandong University of Science and Technology, Qingdao (CN)

(72) Inventors: Ying WANG, Tai'an City (CN); Huigong NIU, Tai'an City (CN); Zhengqiu LIU, Tai'an City (CN)

(21) Appl. No.: 18/068,743

(22) Filed: Dec. 20, 2022

(30) Foreign Application Priority Data
Oct. 20, 2022 (CN) 202211288509.1

(51) Int. Cl. G06N 3/006; G06F 18/2135; G06F 18/2337; G06F 18/2411; G06F 18/27

(52) U.S. Cl. CPC G06N 3/006; G06F 18/2135; G06F 18/2337; G06F 18/2411; G06F 18/27

(57) ABSTRACT

Provided is a method and system for predicting a height of a confined water rising zone. The method includes: obtaining sample data; dividing the sample data into a training sample and a test sample; calculating a degree of correlation between a height and a correlation factor value sequence; screening correlation factors according to the degree of correlation to obtain screened correlation factors; calculating weights of the screened correlation factors using an entropy weight method (EWM); obtaining standardized screened correlation factor value sequences according to correlation factor value sequences corresponding to the screened correlation factors; calculating a value of each indicator according to the standardized screened correlation factor value sequences and the weights; and obtaining a height prediction model of a confined water rising zone based on principal component analysis (PCA)-particle swarm optimization (PSO)-support vector regression (SVR), the value of each indicator, and the test sample.

### CROSS REFERENCE TO RELATED APPLICATION

This patent application claims the benefit and priority of Chinese Patent Application No. 202211288509.1, filed with the China National Intellectual Property Administration on Oct. 20, 2022, the disclosure of which is incorporated by reference herein in its entirety as part of the present application.

### TECHNICAL FIELD

The present disclosure relates to the technical field of coal mine safety production, and in particular, to a method and system for predicting a height of a confined water rising zone.

### BACKGROUND

The confined water rising zone refers to the height at which the water in the confined aquifer rises up along the fault fracture zone or splitting that runs through the aquifer and the upper water-resisting layer under the action of water pressure and capillary negative pressure. It is called the confined water rising zone because it has the original nature without being affected by external human activities. The confined water rising zone has the following characteristics. (1) The rock presents plastic or semi-plastic state due to the dissolution of water. (2) The distribution of the confined water rising zone is uneven and discontinuous, and its development is affected by many factors, so it is difficult to follow the rules. (3) The rock stratum with the confined water rising zone has no water-resisting property, and its water blocking capacity is reduced, so it has certain water permeability. (4) The confined water rising zone of the water-resisting layer has a great subtractive effect on the water head of the aquifer, and the actual water head pressure acting on the effective water-resisting layer is far less than the water head pressure of the aquifer. (5) Stress dissolution and capillary negative pressure are the driving forces for the development of the confined water rising zone, while capillary negative pressure is closely related to the liquid surface tension coefficient and capillary diameter, that is, a greater surface tension coefficient indicates denser and more elongated fractures, which is conducive to the development of the confined water rising zone. With the deepening of coal mining year by year, the water hazard of Ordovician limestone confined aquifer in North China type coalfields is becoming increasingly serious, and 10% of coal mines are threatened by water inrush from confined aquifer to varying degrees. The development height of the confined water rising zone is a factor that directly affects the floor water inrush, and plays a crucial role in judging the floor water inrush risk. A greater development height of the confined water rising zone indicates a smaller thickness of the water-resisting layer and a greater possibility of water inrush from the floor. Therefore, a method for accurately predicting the development height of the confined water rising zone has great contribution and significance to guide the safety production of the mine.

The patent 201410503595.2 discloses a method for predicting a confined water rising zone of the floor. First, a back propagation (BP) neural network model is established to divide the complexity of geological structures into four levels: simple, relatively simple, relatively complex, and complex. Then, according to the geological and hydrological conditions of the prediction area, the water rich area and its water rich property of the prediction area are delineated. Then, according to the overlapping area determined by the relatively complex and complex geological structure areas and the water rich area, the confined water rising zone of the floor in the prediction area is delineated. Finally, the BP neural network prediction model is established using MATLAB to predict the height of the delineated confined water rising zone of the floor. However, the BP neural network method has the following disadvantages. 1) Local minimization problem: from a mathematical point of view, the traditional BP neural network is an optimization method for local search, which aims to solve a complex nonlinear problem. The network weights are gradually adjusted in the direction of local improvement, which will make the algorithm fall into local extremum, and the weights converge to local minima, leading to network training failure. In addition, the BP neural network is very sensitive to the initial network weight, and when the network is initialized with different weights, it tends to converge to different local minima, which is the fundamental reason why many scholars get different results in each training. 2) Low convergence speed of BP neural network algorithm. 3) Different structures of BP neural network. 4) Contradiction between application instances and network scale. 5) Contradiction between prediction ability and training ability of BP neural network. 6) Sample dependence of BP neural network. In addition, the BP neural network prediction model in the patent 201410503595.2 has few selected influencing factors, which is not comprehensive enough. Moreover, the prediction is not made according to the influence degree of different influencing factors on the development height of the confined water rising zone, but according to the same influence degree of the selected influencing factors, which results in the inaccuracy of the predicted height.

### SUMMARY

An objective of the present disclosure is to provide a method and system for predicting a height of a confined water rising zone, which can well overcome the shortcomings of empirical formula and neural network in small sample prediction, and obtains results with high accuracy.

To achieve the above objective, the present disclosure provides the following technical solutions:

A method for predicting a height of a confined water rising zone includes:

obtaining sample data, where the sample data includes heights of multiple confined water rising zones and multiple correlation factor value sequences; each of the correlation factor value sequences includes values of a same correlation factor of all of the confined water rising zones; and correlation factors include a mining depth of a coal seam, a unit water inflow exposed by a confined floor, a thickness of an aquifer, a permeability coefficient of the floor, a slope length of a working face, an advancing speed, a mining height, a damage variable of a coal seam floor, a fault strength index, a fault fractal dimension, a pressure of floor confined water, a liquid surface tension coefficient, a fracture coefficient, and a density of floor aquifer water;

dividing the sample data into a training sample and a test sample;

calculating a degree of correlation between the height of the confined water rising zone and the correlation factor value sequence using a grey relational analysis (GRA) method for the height of any confined water rising zone and any correlation factor value sequence in the training sample;

screening the correlation factors according to the degree of correlation between the height of each of the confined water rising zones and each of the correlation factor value sequences to obtain screened correlation factors;

calculating weights of the screened correlation factors using an entropy weight method (EWM);

performing dimensionless processing on correlation factor value sequences corresponding to the screened correlation factors using a fuzzy comprehensive evaluation method to obtain standardized screened correlation factor value sequences;

determining an indicator system according to the screened correlation factors, and calculating a value of each indicator in the indicator system corresponding to the height of each of the confined water rising zones in the training sample according to the standardized screened correlation factor value sequences and the weights of the screened correlation factors; and

obtaining a height prediction model of a confined water rising zone based on principal component analysis (PCA)-particle swarm optimization (PSO)-support vector regression (SVR), the value of each indicator in the indicator system corresponding to the height of each of the confined water rising zones in the training sample, and the test sample, where the height prediction model of a confined water rising zone is configured to predict the height of the confined water rising zone.

Optionally, a process of calculating a degree of correlation between the height of the confined water rising zone and the correlation factor value sequence using a GRA method for the height of any confined water rising zone and any correlation factor value sequence in the training sample specifically includes:

performing dimensionless processing on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone;

calculating an absolute difference between the standardized correlation factor value sequence and the standardized height of the confined water rising zone;

obtaining a correlation coefficient between the height of the confined water rising zone and the correlation factor value sequence according to the absolute difference; and

calculating the degree of correlation between the height of the confined water rising zone and the correlation factor value sequence according to the correlation coefficient.

Optionally, a process of performing dimensionless processing on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone specifically includes:

calculating an average value of the correlation factor value sequences and an average value of the heights of the confined water rising zones in the training sample according to the correlation factor value sequences and the heights of the confined water rising zones in the training sample;

obtaining a standard deviation of the correlation factor value sequences and a standard deviation of the heights of the confined water rising zones in the training sample according to the average value of the correlation factor value sequences, the average value of the heights of the confined water rising zones, and the correlation factor value sequences and the heights of the confined water rising zones in the training sample; and

standardizing the correlation factor value sequence and the height of the confined water rising zone according to the average value of the correlation factor value sequences, the average value of the heights of the confined water rising zones, the standard deviation of the correlation factor value sequences, and the standard deviation of the heights of the confined water rising zones in the training sample for the height of any confined water rising zone and any correlation factor value sequence in the training sample to obtain the standardized correlation factor value sequence and the standardized height of the confined water rising zone.

Optionally, a process of obtaining a height prediction model of a confined water rising zone based on PCA-PSO-SVR, the value of each indicator in the indicator system corresponding to the height of each of the confined water rising zones in the training sample, and the test sample specifically includes:

calculating a weight of each indicator using PCA according to the value of each indicator in the indicator system corresponding to the height of each of the confined water rising zones in the training sample;

weighting the value of each indicator in the indicator system corresponding to the height of the confined water rising zone according to the weight of each indicator for the height of any confined water rising zone in the training sample to obtain a weighted indicator; and

obtaining the height prediction model of a confined water rising zone using PSO-SVR according to the weighted indicator and the test sample.

Optionally, a process of obtaining the height prediction model of a confined water rising zone using PSO-SVR according to the weighted indicator and the test sample specifically includes:

initializing a particle swarm, where the particle swarm includes multiple groups of parameters of an SVR model, and each group of parameters includes a penalty factor coefficient and a kernel function;

substituting the weighted indicator into an SVR model corresponding to the parameters to obtain fitness of the SVR model corresponding to the parameters; and

determining whether a target model is an optimal target model according to the test sample to obtain a first determination result, where the target model is an SVR model corresponding to a parameter with maximum fitness,

if the first determination result is yes, determining that the target model is the height prediction model of a confined water rising zone; and

if the first determination result is no, updating the particle swarm and returning to the step of “substituting the weighted indicator into an SVR model corresponding to the parameters to obtain fitness of the SVR model corresponding to the parameters”.

A system for predicting a height of a confined water rising zone includes:

an obtaining module configured to obtain sample data, where the sample data includes heights of multiple confined water rising zones and multiple correlation factor value sequences; each of the correlation factor value sequences includes values of a same correlation factor of all of the confined water rising zones; and correlation factors include a mining depth of a coal seam, a unit water inflow exposed by a confined floor, a thickness of an aquifer, a permeability coefficient of the floor, a slope length of a working face, an advancing speed, a mining height, a damage variable of a coal seam floor, a fault strength index, a fault fractal dimension, a pressure of floor confined water, a liquid surface tension coefficient, a fracture coefficient, and a density of floor aquifer water;

a training sample and test sample generation module configured to divide the sample data into a training sample and a test sample;

a correlation degree calculation module configured to calculate a degree of correlation between the height of the confined water rising zone and the correlation factor value sequence using a GRA method for the height of any confined water rising zone and any correlation factor value sequence in the training sample;

a correlation factor screening module configured to screen the correlation factors according to the degree of correlation between the height of each of the confined water rising zones and each of the correlation factor value sequences to obtain screened correlation factors;

a weight calculation module configured to calculate weights of the screened correlation factors using an EWM;

a standardizing module configured to perform dimensionless processing on correlation factor value sequences corresponding to the screened correlation factors using a fuzzy comprehensive evaluation method to obtain standardized screened correlation factor value sequences;

an indicator calculation module configured to determine an indicator system according to the screened correlation factors, and calculate a value of each indicator in the indicator system corresponding to the height of each of the confined water rising zones in the training sample according to the standardized screened correlation factor value sequences and the weights of the screened correlation factors; and

a module for determining a height prediction model of a confined water rising zone configured to obtain a height prediction model of a confined water rising zone based on PCA-PSO-SVR, the value of each indicator in the indicator system corresponding to the height of each of the confined water rising zones in the training sample, and the test sample, where the height prediction model of a confined water rising zone is configured to predict the height of the confined water rising zone.

Optionally, the correlation degree calculation module specifically includes:

a standardizing unit configured to perform dimensionless processing on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone;

an absolute difference calculation unit configured to calculate an absolute difference between the standardized correlation factor value sequence and the standardized height of the confined water rising zone;

a correlation coefficient calculation unit configured to obtain a correlation coefficient between the height of the confined water rising zone and the correlation factor value sequence according to the absolute difference; and

a correlation degree calculation unit configured to calculate the degree of correlation between the height of the confined water rising zone and the correlation factor value sequence according to the correlation coefficient.

Optionally, the standardizing unit specifically includes:

an average value calculation subunit configured to calculate an average value of the correlation factor value sequences and an average value of the heights of the confined water rising zones in the training sample according to the correlation factor value sequences and the heights of the confined water rising zones in the training sample;

a standard deviation calculation subunit configured to obtain a standard deviation of the correlation factor value sequences and a standard deviation of the heights of the confined water rising zones in the training sample according to the average value of the correlation factor value sequences, the average value of the heights of the confined water rising zones, and the correlation factor value sequences and the heights of the confined water rising zones in the training sample; and

a standardizing subunit configured to standardize the correlation factor value sequence and the height of the confined water rising zone according to the average value of the correlation factor value sequences, the average value of the heights of the confined water rising zones, the standard deviation of the correlation factor value sequences, and the standard deviation of the heights of the confined water rising zones in the training sample for the height of any confined water rising zone and any correlation factor value sequence in the training sample to obtain the standardized correlation factor value sequence and the standardized height of the confined water rising zone.

Optionally, the module for determining a height prediction model of a confined water rising zone specifically includes:

a weight calculation unit configured to calculate a weight of each indicator using PCA according to the value of each indicator in the indicator system corresponding to the height of each of the confined water rising zones in the training sample;

a weighting unit configured to weight the value of each indicator in the indicator system corresponding to the height of the confined water rising zone according to the weight of each indicator for the height of any confined water rising zone in the training sample to obtain a weighted indicator; and

a unit for determining a height prediction model of a confined water rising zone configured to obtain the height prediction model of a confined water rising zone using PSO-SVR according to the weighted indicator and the test sample.

Optionally, the unit for determining a height prediction model of a confined water rising zone specifically includes:

an initializing subunit configured to initialize a particle swarm, where the particle swarm includes multiple groups of parameters of an SVR model, and each group of parameters includes a penalty factor coefficient and a kernel function;

a fitness calculation subunit configured to substitute the weighted indicator into an SVR model corresponding to each group of parameters to obtain fitness of the SVR model corresponding to each group of parameters;

a determination subunit configured to determine whether a target model is an optimal target model according to the test sample to obtain a first determination result, where the target model is an SVR model corresponding to a parameter with maximum fitness;

a first result determination subunit configured to determine that the target model is the height prediction model of a confined water rising zone if the first determination result is yes; and

a second result determination subunit configured to update the particle swarm and return to the step of “substituting the weighted indicator into an SVR model corresponding to each group of parameters to obtain fitness of the SVR model corresponding to each group of parameters” if the first determination result is no.

According to the specific embodiments provided by the present disclosure, the present disclosure discloses the following technical effects: on the basis of taking into account as many correlation factors affecting the development of the confined water rising zone as possible, the present disclosure screens the correlation factors, and obtains the height prediction model of a confined water rising zone based on PCA-PSO-SVR, so as to achieve a more practical prediction process, thereby overcoming the shortcomings of empirical formula and neural network in small sample prediction and improving the final prediction accuracy, which has excellent feasibility in predicting the confined water rising zone.

### BRIEF DESCRIPTION OF THE DRAWINGS

To describe the embodiments of the present disclosure or the technical solutions in the related art more clearly, the accompanying drawings required in the embodiments are briefly introduced below. Obviously, the accompanying drawings described below are only some embodiments of the present disclosure. Those of ordinary skill in the art may further obtain other accompanying drawings based on these accompanying drawings without creative labor.

FIG. 1 is a flow chart of a method for predicting a height of a confined water rising zone provided by an embodiment of the present disclosure;

FIG. 2 is a flow chart of screening correlation factors with strong correlation with the confined water rising zone based on a MATLAB platform and establishing an indicator system of a prediction model according to the correlation factors;

FIG. 3 is a flow chart of establishing a height prediction model of a confined water rising zone;

FIG. 4 shows a curve of fitness changing with evolutionary algebra;

FIG. 5 shows a training sample fitting curve; and

FIG. 6 shows a test sample fitting curve.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

To make the above-mentioned objective, features, and advantages of the present disclosure clearer and more comprehensible, the present disclosure will be further described in detail below in conjunction with the accompanying drawings and specific embodiments.

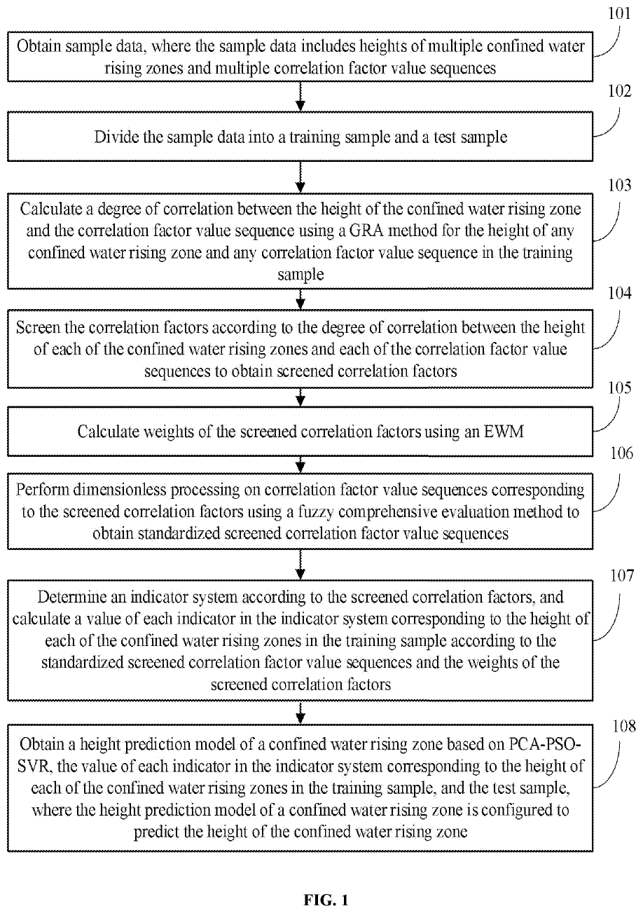

As shown in FIG. 1, the embodiment of the present disclosure provides a method for predicting a height of a confined water rising zone, including the following steps. Step 101: Sample data is obtained. The sample data includes heights of multiple confined water rising zones and multiple correlation factor value sequences. Each of the correlation factor value sequences includes values of a same correlation factor of all of the confined water rising zones. Correlation factors include a mining depth of a coal seam, a unit water inflow exposed by a confined floor, a thickness of an aquifer, a permeability coefficient of the floor, a slope length of a working face, an advancing speed, a mining height, a damage variable of a coal seam floor, a fault strength index, a fault fractal dimension, a pressure of floor confined water, a liquid surface tension coefficient, a fracture coefficient, and a density of floor aquifer water;

Step 102: The sample data is divided into a training sample and a test sample.

Step 103: A degree of correlation between the height of the confined water rising zone and the correlation factor value sequence is calculated using a GRA method for the height of any confined water rising zone and any correlation factor value sequence in the training sample.

Step 104: The correlation factors are screened according to the degree of correlation between the height of each of the confined water rising zones and each of the correlation factor value sequences to obtain screened correlation factors.

Step 105: Weights of the screened correlation factors are calculated using an EWM.

Step 106: Dimensionless processing is performed on correlation factor value sequences corresponding to the screened correlation factors using a fuzzy comprehensive evaluation method to obtain standardized screened correlation factor value sequences.

Step 107: An indicator system is determined according to the screened correlation factors, and a value of each indicator in the indicator system corresponding to the height of each of the confined water rising zones in the training sample is calculated according to the standardized screened correlation factor value sequences and the weights of the screened correlation factors.

Step 108: A height prediction model of a confined water rising zone is obtained based on PCA-PSO-SVR, the value of each indicator in the indicator system corresponding to the height of each of the confined water rising zones in the training sample, and the test sample. The height prediction model of a confined water rising zone is configured to predict the height of the confined water rising zone. In the document “Research on annual runoff forecast of Danjiangkou Reservoir based on PCA-PSO-SVR”, PCA and PSO algorithms are added to the SVR model to establish a PCA-PSO-SVR prediction model, so as to eliminate redundant information and noise, extract the main features among factors, and select the optimal combination of model parameters as the input of the SVR model. The Danjiangkou Reservoir, the water source of the middle route of the South-to-North Water Transfer Project (MSWTP), is selected as the study area, and the model test is conducted by using the data of Danjiangkou reservoir from 1981 to 2016.

In practical application, a process of calculating a degree of correlation between the height of the confined water rising zone and the correlation factor value sequence using a GRA method for the height of any confined water rising zone and any correlation factor value sequence in the training sample specifically includes the following substeps.

Dimensionless processing is performed on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone.

An absolute difference between the standardized correlation factor value sequence and the standardized height of the confined water rising zone is calculated.

A correlation coefficient between the height of the confined water rising zone and the correlation factor value sequence is obtained according to the absolute difference.

The degree of correlation between the height of the confined water rising zone and the correlation factor value sequence is calculated according to the correlation coefficient.

In practical application, a process of performing dimensionless processing on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone specifically includes the following substeps.

An average value of the correlation factor value sequences and an average value of the heights of the confined water rising zones in the training sample are calculated according to the correlation factor value sequences and the heights of the confined water rising zones in the training sample.

A standard deviation of the correlation factor value sequences and a standard deviation of the heights of the confined water rising zones in the training sample are obtained according to the average value of the correlation factor value sequences, the average value of the heights of the confined water rising zones, and the correlation factor value sequences and the heights of the confined water rising zones in the training sample.

The correlation factor value sequence and the height of the confined water rising zone are standardized according to the average value of the correlation factor value sequences, the average value of the heights of the confined water rising zones, the standard deviation of the correlation factor value sequences, and the standard deviation of the heights of the confined water rising zones in the training sample for the height of any confined water rising zone and any correlation factor value sequence in the training sample to obtain the standardized correlation factor value sequence and the standardized height of the confined water rising zone.

In practical application, a process of obtaining a height prediction model of a confined water rising zone based on PCA-PSO-SVR, the value of each indicator in the indicator system corresponding to the height of each of the confined water rising zones in the training sample, and the test sample specifically includes the following substeps.

A weight of each indicator is calculated using PCA according to the value of each indicator in the indicator system corresponding to the height of each of the confined water rising zones in the training sample.

The value of each indicator in the indicator system corresponding to the height of the confined water rising zone is weighted according to the weight of each indicator for the height of any confined water rising zone in the training sample to obtain a weighted indicator.

The height prediction model of a confined water rising zone is obtained using PSO-SVR according to the weighted indicator and the test sample.

In practical application, a process of obtaining the height prediction model of a confined water rising zone using PSO-SVR according to the weighted indicator and the test sample specifically includes the following substeps.

A particle swarm is initialized. The particle swarm includes multiple groups of parameters of an SVR model, and each group of parameters includes a penalty factor coefficient and a kernel function.

The weighted indicator is substituted into an SVR model corresponding to the parameters to obtain fitness of the SVR model corresponding to the parameters.

Whether a target model is an optimal target model is determined according to the test sample to obtain a first determination result. The target model is an SVR model corresponding to a parameter with maximum fitness.

If the first determination result is yes, it is determined that the target model is the height prediction model of a confined water rising zone.

If the first determination result is no, the particle swarm is updated (with formulas 21 and 22) and the method returns to the step of “substituting the weighted indicator into an SVR model corresponding to the parameters to obtain fitness of the SVR model corresponding to the parameters”.

The present embodiment provides a more specific method for predicting a height of a confined water rising zone, including the following specific steps.

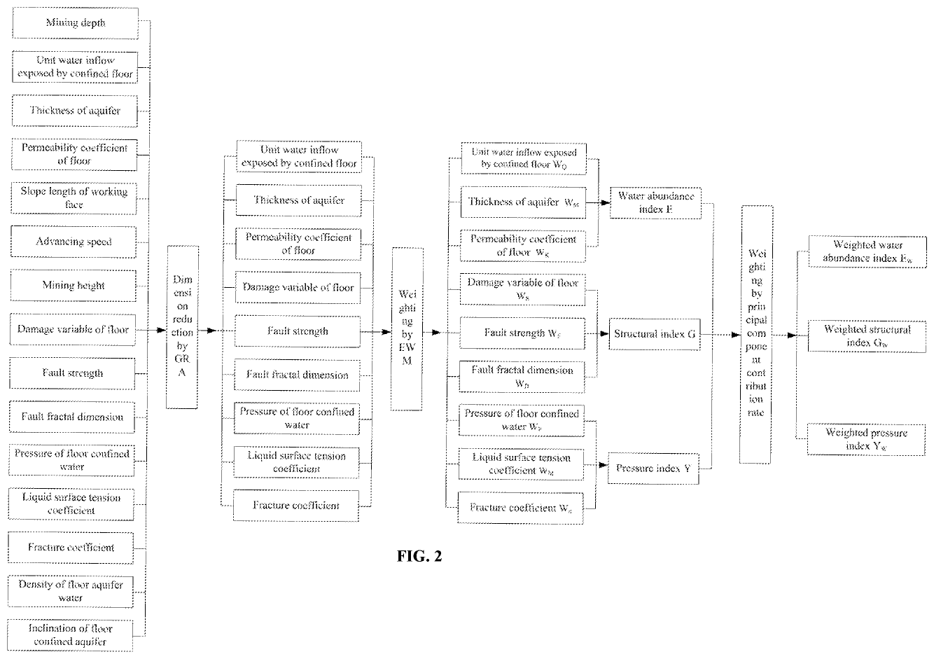

Step I: Based on a MATLAB platform, correlation factors with strong correlation with the confined water rising zone are screened, and an indicator system of a prediction model is established according to the correlation factors. As shown in FIG. 2, a specific process is as follows.

(1) The area developed with the confined water rising zone in the study area is determined, and relevant sample data is collected. The data of each sample includes a height of a confined water rising zone, a mining depth of a coal seam, a unit water inflow exposed by a confined floor, a thickness of an aquifer, a permeability coefficient of the floor, a slope length of a working face, an advancing speed, a mining height, a damage variable of a coal seam floor, a fault strength index, a fault fractal dimension, a pressure of floor confined water, a liquid surface tension coefficient, a fracture coefficient, and a density of floor aquifer water.

(2) The collected sample data is divided into a training sample and a test sample. Dimensionless processing is performed on each correlation factor and data of the training sample using a fuzzy theory.

Y₁, Y₂, Y₃, . . . , Yₙ are set as sequences of the heights of the confined water rising zone. Yₙ represents a sequence of the heights of an n-th confined water rising zone, and Yₙ={yₙ}, where yₙ represents the height of the n-th confined water rising zone. X₁, X₂, X₃, . . . , Xₘ are correlation factor sequences, Xₗ represents a sequence of coal seam mining depths of all of the confined water rising zones, and Xₗ={xₗ}, where Xₗ represents the coal seam mining depth of all of the confined water rising zones, and X₂ is a sequence of water inflow corresponding to all heights... By analogy, Yᵢ(l<i≤n) and Xⱼ(l<j≤m) have the same time length, that is, the number of data is the same. In addition, Yᵢ is set as a parent sequence, and m correlation factor sequences Xⱼ are set as child sequences.

The following is defined:

$$\overline{x} = \frac{1}{m} {\sum }_{j = 1}^{m} {x}_{j} , \overline{y} = \frac{1}{n} {\sum }_{i = 1}^{n} {y}_{i} , \qquad Formula 1$$

where x̅ and y̅ are average values of original data of the correlation factor sequences and

the sequences of the heights of the confined water rising zone respectively.

$${s}_{1} = \frac{1}{m - 1} {\sum }_{j = 1}^{m} {( {x}_{j} - \overline{x} )}^{2} , {s}_{2} = \frac{1}{n - 1} {\sum }_{i = 1}^{n} {( {y}_{i} , - \overline{y} )}^{2} , \qquad Formula 2$$

where S1 and S2 are standard deviations of original data of the correlation factor sequences and the sequences of the heights of the confined water rising zone respectively.

$$\\ \begin{matrix}{x}_{j}^{{}^{} ′} = \frac{{x}_{j} - \overline{x}}{{s}_{1}} , {y}_{i}^{{}^{} ′} = \frac{{y}_{i} - \overline{y}}{{s}_{2}} , & Formula 3\end{matrix}$$

where xⱼ′ and yⱼ′ are standardized sequences of the correlation factor sequences and the

sequences of the heights of the confined water rising zone respectively.

(3) A degree of correlation between each correlation factor and the height of the confined water rising zone is calculated using the GRA method to select correlation factors with a degree of correlation greater than 0.8 as the basis for establishing the model indicator system.

A correlation coefficient is calculated.

The standardized parent sequence is recorded as Yᵢ′, the child sequence is Xⱼ′, and an absolute difference between Yᵢ′ and Xⱼ′ is Δᵢⱼk, then:

Δᵢⱼk=|Yᵢ′(k)−Xⱼ′(k)|, Formula 4

where is a Yᵢ′(k) element in the parent sequence and is a Xⱼ′(k) element in the child sequence, then a correlation coefficient between the parent sequence Yᵢ′ and the child sequence Xⱼ′ is:

$$\\ \begin{matrix}{δ}_{ij} ( k ) = \frac{{Δ}_{min} + β {Δ}_{max}}{{Δ}_{ij} k + β {Δ}_{max}} , & Formula 5\end{matrix}$$

where Δₘₐₓ is recorded as a maximum of Δᵢⱼk . Δₘᵢₙ represents a minimum of Δᵢⱼk. β is a standardized coefficient, usually β=0.5.

A degree of correlation is calculated.

A degree of correlation between the parent sequence and the child sequence is calculated:

$$\\ \begin{matrix}{λ}_{ij} = \frac{1}{A} {\sum }_{k = 1}^{n} {δ}_{ij} ( k ) , & Formula 6\end{matrix}$$

where λᵢⱼ represents the degree of correlation between the parent sequence and the child sequence, and A represents a length of the comparison sequence.

(4) Weights of the screened correlation factors are calculated using an EWM.

The present embodiment is solved by the weight function of MATLAB. A calculation process is as follows.

The numbers of evaluation objects and evaluation indicators are determined. An evaluation matrix of multiple objects and multiple indicators is established: an evaluation matrix of multiple objects and multiple indicators is established in (4) according to the selected correlation factors with a degree of correlation greater than 0.8 in (3):

$$\\ \begin{matrix}{R}^{{}^{} ′} = [ \begin{matrix}{γ}_{11}^{{}^{} ′} , {γ}_{12}^{{}^{} ′} , L , {γ}_{1 n}^{{}^{} ′} \\ {γ}_{21}^{{}^{} ′} , {γ}_{22}^{{}^{} ′} , L , {γ}_{2 n}^{{}^{} ′} \\ L \\ {γ}_{m 1}^{{}^{} ′} , {γ}_{m2}^{{}^{} ′} , L , {γ}_{mn}^{{}^{} ′}\end{matrix} ] . & Formula 7\end{matrix}$$

According to

$$\\ \begin{matrix}{γ}_{ij} = \frac{{γ}_{ij}^{{}^{} ′} - min ( {γ}_{ij}^{{}^{} ′} )}{max ( {γ}_{ij}^{{}^{} ′} ) - min ( {γ}_{ij}^{{}^{} ′} )} , & Formula 8\end{matrix}$$

the evaluation matrix R′ is subjected to dimensionless processing to obtain a standardized matrix R=(γₘᵢₙ)_{m×n.}

According to

$$\\ \begin{matrix}{f}_{ij} = \frac{{γ}_{ij}}{{\sum }_{j = 1}^{n} {γ}_{ij}} ( i = 1 , 2 , … , n ; j = 1 , 2 , … , m ) , & Formula 9\end{matrix}$$

the

standardized matrix R is normalized to obtain an entropy value of an i-th evaluation indicator

$$\\ \begin{matrix}{H}_{i} : {H}_{i} = - \frac{1}{ln m} {\sum }_{j = 1}^{m} {f}_{ij} ln {f}_{ij} . & Formula 10\end{matrix}$$

The entropy weight of the i-th evaluation indicator ωᵢ can be expressed as:

$$\\ \begin{matrix}{ω}_{i} = \frac{1 - {H}_{i}}{n - {\sum }_{i = 1}^{n} {H}_{i}} . & Formula 11\end{matrix}$$

(5) Dimensionless processing is performed on the screened correlation factors. The weighted data of correlation factors are divided into three indicators: water abundance index, structural index, and pressure index. The calculation method of the index is as follows:

E=QW_{Q}+MW_{M}+KW_{K,} Formula 12

G=SW_{S}+FW_{F}+DW_{D}, and Formula 13

Y=PW_{P}+MW_{M}+σW_{σ}, Formula 14

where E represents the water abundance index, G represents the structural index, Y represents the pressure index, Q, M, K, S, F, D, P, M, and σ represent a unit water inflow exposed by a confined floor, a thickness of an aquifer, a permeability coefficient of the floor, a damage variable of a coal seam floor, a fault strength index, a fault fractal dimension, a pressure of floor confined water, a liquid surface tension coefficient, and a fracture coefficient after standardization respectively, and W_{Q}, W_{M}, W_{K}, W_{S}, W_{F}, W_{D}, W_{P}, W_{M}, and W_{σ}, represent the weights of the above correlation factors respectively.

(6) The weights of three indicators, namely, the water abundance index, the structural index, and the pressure index are determined using the contribution rate of PCA. Specifically, the present embodiment uses a PCA function to calculate the weights of the water abundance index, the structural index, and the pressure index based on the Matlab platform. The calculation process is as follows.

Each sample is taken as a row vector, and the same discriminant indicator of multiple samples is vertically combined to form a sample matrix. It is supposed that there are n samples, and each sample contains 3 discriminant indicators, namely, the water abundance index, the structural index, and the pressure index (corresponding to the height of the same confined water rising zone), which constitutes a sample matrix of n rows and 3 columns.

Then the sample matrix is standardized to eliminate the dimensional influence. The standardized formula is as follows:

$$\\ \begin{matrix}{B}_{i} = \frac{( {b}_{i} - min ( {b}_{i} ) )}{( max ( {b}_{i} ) - min ( {b}_{i} ) )} , & Formula 15\end{matrix}$$

where Bᵢ is the normalized data, bᵢ is the original data before normalization (column i of the sample matrix), min(b) is the minimum in all original data before normalization, and max(b) is the maximum in all original data before normalization. The final standardized sample matrix is: B=(B₁, B₂, . . . , B_{P})_{n×p}.

The covariance matrix of the solved sample is Σ=Σ(sᵢⱼ)_{p×p} Formula 16,

where

$$\\ \begin{matrix}{s}_{ij} = \frac{1}{n - 1} {\sum }_{k} ( {b}_{ki} - \overline{{B}_{i}} ) ( {x}_{ki} - \overline{{B}_{j}} ) , & Formula 17\end{matrix}$$

where sᵢⱼ is an element in row i and column j of the covariance matrix, bₖᵢ is an element in row k and column i of the sample matrix B, B̅ᵢ̅ is an average value of column i of the sample matrix B, B̅ⱼ̅ is an average value of row j of the sample matrix B, and xₖᵢis an element in row k and column i of the sample matrix B.

The eigenvalues λᵢ and eigenvectors ∂ᵢ of the covariance matrix Σ of sample data are solved by singular value decomposition.

A projection matrix is constructed using the eigenvectors to sort the eigenvalues λᵢ, and the eigenvectors corresponding to the eigenvalues are selected to form the projection matrix:

Y=(∂ₘ₁, ∂ₘ₂, . . . , ∂ₘₖ)_{p×k}, Formula 18

where ∂ₘₖ is the eigenvector corresponding to the k -th eigenvalue , and Y is the proj ection matrix.

The contribution rate of each characteristic root is calculated by using the projection matrix pair. A calculation process is as follows. The comprehensive score coefficient of principal components is determined as:

$$\\ \begin{matrix}δ = {\sum }_{i = m}^{p} {λ}_{1} {\partial }_{i 1} + {\sum }_{i = m}^{p} {λ}_{2} {\partial }_{i 2} + … {\sum }_{i = m}^{p} {λ}_{k} {\partial }_{ik} . & Formula 19\end{matrix}$$

The corresponding contribution rate of each characteristic root is determined as:

$$\\ \begin{matrix}\frac{{\sum }_{i = m}^{p} {λ}_{k} {\partial }_{ik}}{δ} . & Formula 20\end{matrix}$$

The contribution rate of each characteristic root calculated is taken as the weights of the three indicators of the water abundance index, the structural index, and the pressure index, and the three indicators of the water abundance index, the structural index, and the pressure index are weighted.

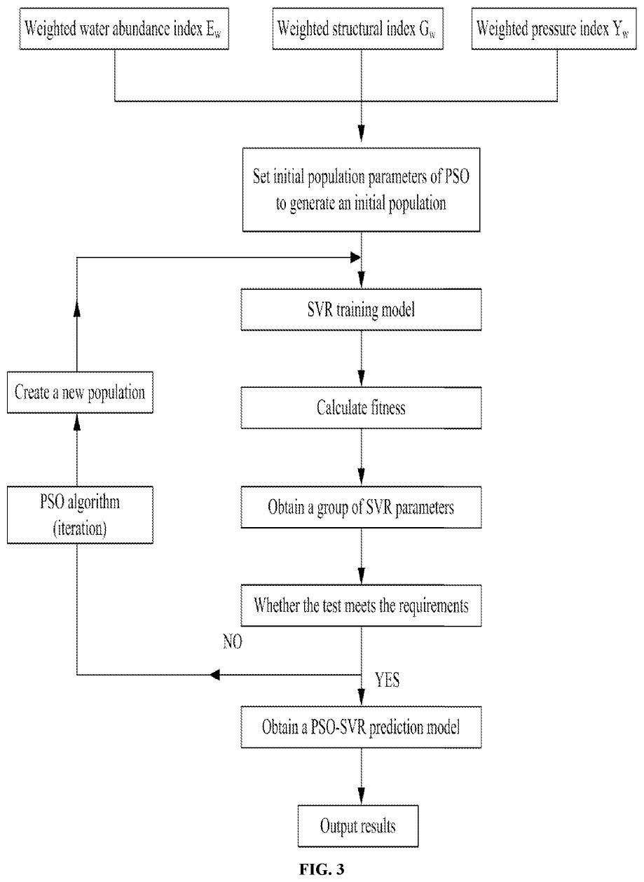

Step II: A height prediction model of a confined water rising zone is established. As shown in FIG. 3, a specific process is as follows.

(1) Taking the weighted water abundance index Ew, structural index Gw, and pressure index Yw and the height of the confined water rising zone as the training sample data, the initial parameters of PSO are set, and the optimal parameters C (penalty factor) and g (kernel function parameter) of SVR are searched by PSO.

Specifically, the initial parameters and training sample data are substituted into the SVR model to calculate the fitness.

SVR in the prior art is specifically as follows.

The data sample is set as an n-dimensional vector, and the training data set is {(xi, yi), . . . , (xl, y1)}, then a regression function used to fit the sample data of the function is:

f(x)=ω×Φ(x)+b Formula 21

where the undetermined parameters ω and b represent the weight vector and offset

respectively.

By introducing C (C>0), the above equation can be expressed as the following constrained optimization problem:

$$\\ \begin{matrix}Min : \frac{1}{2} {ω}^{2} + C {\sum }_{i = 1}^{l} ( ξ + {ξ}^{*} ) , and & Formula 22\end{matrix}$$

$$\\ \begin{matrix}s . t . \{ \begin{matrix}f ( {x}_{i} ) - {y}_{i} \leq ε + {ξ}_{i}^{{}^{} *} , i = 1 , … , l \\ {y}_{i} - f ( {x}_{i} ) \leq ε + {ξ}_{i} , i = 1 , … , l \\ {ξ}_{i}^{{}^{} *} , {ξ}_{i} \geq 0 , i = 1 , … , l\end{matrix} \} , & Formula 23\end{matrix}$$

where ε is an insensitive loss function, the function is to ignore the error of a certain upper and lower range of the real value, and ζ is a relaxation factor.

The above problem is a convex quadratic optimization problem. By introducing Lagrange multipliers and transforming the above constrained optimization problem into its dual problem, the following can be obtained:

$$\\ \begin{matrix}Max : W ( α , {α}^{{}^{} *} ) = - \frac{1}{2} {\sum }_{i , j = 1}^{l} ( {α}_{i} - {α}_{i}^{{}^{} *} ) ( {α}_{j} - {α}_{j}^{{}^{} *} ) K ( {x}_{i} , {x}_{j} ) + {\sum }_{i = 1}^{l} ( {α}_{i} - {α}_{i}^{{}^{} *} ) {y}_{i} - {\sum }_{i = 1}^{l} ( {α}_{i} + {α}_{i}^{{}^{} *} ) ε , & Formula 24\end{matrix}$$

$$\\ \begin{matrix}s . t . {\sum }_{i = 1}^{l} ( {α}_{i} - {α}_{i}^{{}^{} *} ) = 0 , 0 \leq {α}_{i} , {α}_{i}^{{}^{} *} \leq C , & Formula 25\end{matrix}$$

$$\\ \begin{matrix}k ( {x}_{i} , x ) = exp \{ - {\vert x - {x}_{i} \vert}^{2} / 2 {σ}^{{}^{} 2} \} , and & Formula 26\end{matrix}$$

$$\\ \begin{matrix}1 / {σ}^{{}^{} 2} = g , & Formula 27\end{matrix}$$

where K(xᵢ, xⱼ)=[Φ(xᵢ),Φ(xⱼ)] is the kernel function, and α and α* are the

corresponding support vectors.

By solving Formula 25, the corresponding α and α* is obtained, then the optimal fitting function can be determined as:

$$\\ \begin{matrix}f ( x ) = {\sum }_{i = 1}^{l} ( {α}_{i} - {α}_{i}^{{}^{} *} ) K ( {x}_{i} , {x}_{j} ) + b . & Formula 28\end{matrix}$$

The collected test data is taken as the original data for model establishment. First, the PSO algorithm is used to determine the initial population parameters.

(2) The test sample is substituted into the SVR model with the minimum fitness to calculate the mean square error (MSE). A learning sample fitting graph is obtained through sample mapping calculation and linear fitting training. The learning effect is evaluated according to the MSE of fitting degree. An MSE tending to zero indicates a more excellent learning effect, indicating that the model has excellent generalization and meets the requirements. Thus, this prediction model can be used to predict the height of the confined water rising zone. When the prediction is made again, the predicted height of the confined water rising zone can be directly obtained by inputting the original data. If the average value of MSE is large and the learning effect is poor, the original population will generate a new population through iteration, the fitness is recalculated, and the model is retrained, and so on until an excellent effect is achieved. (Because each particle has a memory function, the effect must be better each time. After getting a new model, testing is performed again until the optimal model is obtained.)

The new parameter population generated by POS is calculated according to the following formulas:

v_{id}^{k}=wv_{id}^{k-1}+c₁r₁(pbest_{id}−x_{id}^{k-1})+c₂r₂(gbest_{d}−x_{id}^{k-1}), Formula 29

and

x_{id}^{k}=x_{id}^{k-1}+v_{id}^{k-1}, Formula 30

where c1 and c2 are acceleration factors usually with an initial value of 1.49, r1 and r2 are rand random functions of [0,1], w is called inertia weight usually with an initial value of 0.8, and k represents the number of iterations.

Finally, after a lot of training and learning, the optimal parameters C and g are found. (C controls the error of the training sample. A larger C indicates a more excellent training effect but a lower generalization ability. The width coefficient g reflects the degree of correlation between the support vectors. A larger g indicates a looser relationship between the support vectors. A smaller g indicates a greater influence between the support vectors).

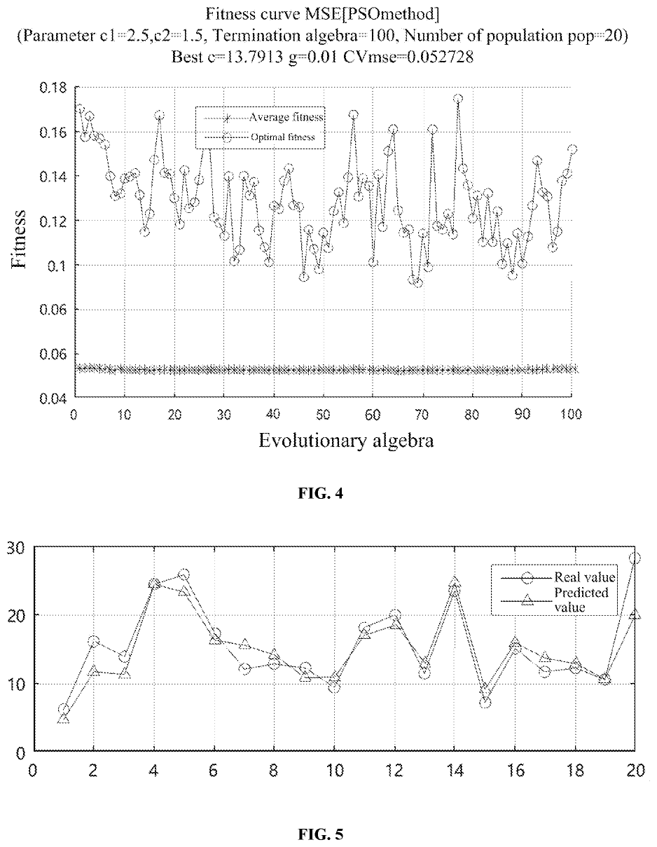

FIG. 4 shows a curve of fitness changing with evolutionary algebra in the PSO-SVR prediction model, which can better observe the changes of fitness during iteration.

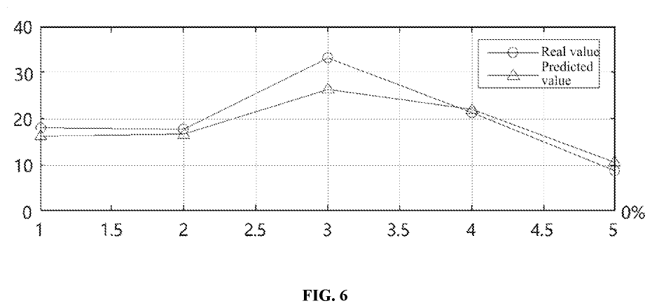

FIG. 5 shows a training sample fitting curve in the PSO-SVR prediction model, which can better observe the error between the real value and the predicted value of the training sample.

FIG. 6 shows a test sample fitting curve in the PSO-SVR prediction model, which can better observe the error between the real value and the predicted value of the test sample.

The embodiment of the present disclosure further provides a system for predicting a height of a confined water rising zone, including: an obtaining module, a training sample and test sample generation module, a correlation degree calculation module, a correlation factor screening module, a weight calculation module, a standardizing module, an indicator calculation module, and a module for determining a height prediction model of a confined water rising zone.

The obtaining module is configured to obtain sample data. The sample data includes heights of multiple confined water rising zones and multiple correlation factor value sequences. Each of the correlation factor value sequences includes values of a same correlation factor of all of the confined water rising zones. Correlation factors include a mining depth of a coal seam, a unit water inflow exposed by a confined floor, a thickness of an aquifer, a permeability coefficient of the floor, a slope length of a working face, an advancing speed, a mining height, a damage variable of a coal seam floor, a fault strength index, a fault fractal dimension, a pressure of floor confined water, a liquid surface tension coefficient, a fracture coefficient, and a density of floor aquifer water.

The training sample and test sample generation module is configured to divide the sample data into a training sample and a test sample.

The correlation degree calculation module is configured to calculate a degree of correlation between the height of the confined water rising zone and the correlation factor value sequence using a GRA method for the height of any confined water rising zone and any correlation factor value sequence in the training sample.

The correlation factor screening module is configured to screen the correlation factors according to the degree of correlation between the height of each of the confined water rising zones and each of the correlation factor value sequences to obtain screened correlation factors.

The weight calculation module is configured to calculate weights of the screened correlation factors using an EWM.

The standardizing module is configured to perform dimensionless processing on correlation factor value sequences corresponding to the screened correlation factors using a fuzzy comprehensive evaluation method to obtain standardized screened correlation factor value sequences.

The indicator calculation module is configured to determine an indicator system according to the screened correlation factors, and calculate a value of each indicator in the indicator system corresponding to the height of each of the confined water rising zones in the training sample according to the standardized screened correlation factor value sequences and the weights of the screened correlation factors.

The module for determining a height prediction model of a confined water rising zone is configured to obtain a height prediction model of a confined water rising zone based on PCA-PSO-SVR, the value of each indicator in the indicator system corresponding to the height of each of the confined water rising zones in the training sample, and the test sample. The height prediction model of a confined water rising zone is configured to predict the height of the confined water rising zone.

As an optional implementation, the correlation degree calculation module specifically includes: a standardizing unit, an absolute difference calculation unit, a correlation coefficient calculation unit, and a correlation degree calculation unit.

The standardizing unit is configured to perform dimensionless processing on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone.

The absolute difference calculation unit is configured to calculate an absolute difference between the standardized correlation factor value sequence and the standardized height of the confined water rising zone.

The correlation coefficient calculation unit is configured to obtain a correlation coefficient between the height of the confined water rising zone and the correlation factor value sequence according to the absolute difference.

The correlation degree calculation unit is configured to calculate the degree of correlation between the height of the confined water rising zone and the correlation factor value sequence according to the correlation coefficient.

As an optional implementation, the standardizing unit specifically includes: an average value calculation subunit, a standard deviation calculation subunit, and a standardizing subunit.

The average value calculation subunit is configured to calculate an average value of the correlation factor value sequences and an average value of the heights of the confined water rising zones in the training sample according to the correlation factor value sequences and the heights of the confined water rising zones in the training sample.

The standard deviation calculation subunit is configured to obtain a standard deviation of the correlation factor value sequences and a standard deviation of the heights of the confined water rising zones in the training sample according to the average value of the correlation factor value sequences, the average value of the heights of the confined water rising zones, and the correlation factor value sequences and the heights of the confined water rising zones in the training sample.

The standardizing subunit is configured to standardize the correlation factor value sequence and the height of the confined water rising zone according to the average value of the correlation factor value sequences, the average value of the heights of the confined water rising zones, the standard deviation of the correlation factor value sequences, and the standard deviation of the heights of the confined water rising zones in the training sample for the height of any confined water rising zone and any correlation factor value sequence in the training sample to obtain the standardized correlation factor value sequence and the standardized height of the confined water rising zone.

As an optional implementation, the module for determining a height prediction model of a confined water rising zone specifically includes: a weight calculation unit, a weighting unit, and a unit for determining a height prediction model of a confined water rising zone.

The weight calculation unit is configured to calculate a weight of each indicator using PCA according to the value of each indicator in the indicator system corresponding to the height of each of the confined water rising zones in the training sample.

The weighting unit is configured to weight the value of each indicator in the indicator system corresponding to the height of the confined water rising zone according to the weight of each indicator for the height of any confined water rising zone in the training sample to obtain a weighted indicator.

The unit for determining a height prediction model of a confined water rising zone is configured to obtain the height prediction model of a confined water rising zone using PSO-SVR according to the weighted indicator and the test sample.

As an optional implementation, the unit for determining a height prediction model of a confined water rising zone specifically includes: an initializing subunit, a fitness calculation subunit, a determination subunit, a first result determination subunit, and a second result determination subunit.

The initializing subunit is configured to initialize a particle swarm. The particle swarm includes multiple groups of parameters of an SVR model, and each group of parameters includes a penalty factor coefficient and a kernel function.

The fitness calculation subunit is configured to substitute the weighted indicator into an SVR model corresponding to each group of parameters to obtain fitness of the SVR model corresponding to each group of parameters.

The determination subunit is configured to determine whether a target model is an optimal target model according to the test sample to obtain a first determination result. The target model is an SVR model corresponding to a parameter with maximum fitness.

The first result determination subunit is configured to determine that the target model is the height prediction model of a confined water rising zone if the first determination result is yes.

The second result determination subunit is configured to update the particle swarm and return to the step of “substituting the weighted indicator into an SVR model corresponding to each group of parameters to obtain fitness of the SVR model corresponding to each group of parameters” if the first determination result is no.

The present disclosure has the following technical effects:

The present disclosure can overcome the limitations of traditional empirical formula and neural network in predicting small and medium samples, has strong generalization ability and high accuracy, and has excellent feasibility in the method for predicting a height of a confined water rising zone. On the basis of ensuring the accuracy of the prediction, a height prediction model of a confined water rising zone is established, namely: the Fuzzy-GRA-EWM-PCA-PSO-SVR prediction model, which can deepen the understanding of the development mechanism of the confined water rising zone, provides a theoretical basis for the prediction and prevention of water inrush from the confined aquifer and coal mine safety production, and can be applied to field prediction.

The present disclosure is not simply calculated by traditional formula. The number of coefficient parameters in the traditional formula is very limited, and the factors affecting the development of the confined water rising zone cannot be taken into account more comprehensively, resulting in a large error in the calculation results. Moreover, the correlation between the factors affecting the development of the confined water rising zone and the height of the confined water rising zone in the traditional formula method is too simple, and the generalization is very poor. On the basis of taking into account as many correlation factors affecting the development of the confined water rising zone as possible (14 influencing factors are taken into account), the present disclosure first refines and reduces the dimensions by using the GRA method, and selects and refines the influencing factors with a degree of correlation greater than 0.8 as the basis for establishing the model indicator system. The EWM is used to weight the extracted influencing factors. The fuzzy analysis method is used to refine the influencing factors, which are divided into three indexes: water abundance index, structural index, and pressure index. Through multiple refining, dimension reduction, and weighting, the influence degree of each influencing factor and indicator is continuously distinguished by quantitative weighting, so as to achieve a more practical prediction process and improve the final prediction accuracy. In addition, the PSO-SVR can search for optimal parameters through continuous iteration to determine the final prediction model. The method has great advantages in solving multi-objective optimization problems, has excellent universality, is suitable for dealing with multiple types of objective functions and constraints, and is easy to combine with traditional optimization methods, so as to improve its own limitations, so it is more accurate than traditional formula methods.

Each embodiment of the present specification is described in a progressive manner, each embodiment focuses on the difference from other embodiments, and the same and similar parts between the embodiments may refer to each other. Since the system disclosed in an embodiment corresponds to the method disclosed in another embodiment, the description is relatively simple, and reference can be made to the method description.

Various components and/or steps illustrated in the figures and/or described may be implemented as software and/or firmware on a processor, controller, ASIC, FPGA, and/or dedicated hardware. In some cases, there is provided a non-transitory computer readable medium storing instructions, which when executed by at least one computing or processing device, cause performing any of the methods as generally shown and/or described herein and equivalents thereof.

Specific examples are used herein to explain the principles and embodiments of the present disclosure. The foregoing description of the embodiments is merely intended to help understand the method of the present disclosure and its core ideas; besides, various modifications may be made by those of ordinary skill in the art to specific embodiments and the scope of application in accordance with the ideas of the present disclosure. In conclusion, the content of the present specification shall not be construed as limitations to the present disclosure.

What is claimed is:

1. A method for predicting a height of a confined water rising zone, comprising:
obtaining sample data, wherein the sample data comprises heights of multiple confined water rising zones and multiple correlation factor value sequences; each of the multiple correlation factor value sequences comprises values of a same correlation factor of all of the multiple confined water rising zones; and correlation factors comprise a mining depth of a coal seam, a unit water inflow exposed by a confined floor, a thickness of an aquifer, a permeability coefficient of the confined floor, a slope length of a working face, an advancing speed, a mining height, a damage variable of a coal seam floor, a fault strength index, a fault fractal dimension, a pressure of floor confined water, a liquid surface tension coefficient, a fracture coefficient, and a density of floor aquifer water;
dividing the sample data into a training sample and a test sample;
calculating a degree of correlation between the height of a confined water rising zone of the multiple confined water rising zones and a correlation factor value sequence of the multiple correlation factor value sequences using a grey relational analysis (GRA) method for the height of any confined water rising zone and any correlation factor value sequence in the training sample;
screening the correlation factors according to the degree of correlation between the height of each of the multiple confined water rising zones and each of the multiple correlation factor value sequences to obtain screened correlation factors;
calculating weights of the screened correlation factors using an entropy weight method (EWM);
performing dimensionless processing on correlation factor value sequences corresponding to the screened correlation factors using a fuzzy comprehensive evaluation method to obtain standardized screened correlation factor value sequences;
determining an indicator system according to the screened correlation factors, and calculating a value of each indicator in the indicator system corresponding to the height of each of the multiple confined water rising zones in the training sample according to the standardized screened correlation factor value sequences and the weights of the screened correlation factors; and
obtaining a height prediction model of a confined water rising zone based on principal component analysis (PCA)-particle swarm optimization (PSO)-support vector regression (SVR), the value of each indicator in the indicator system corresponding to the height of each of the multiple confined water rising zones in the training sample, and the test sample, wherein the height prediction model of a confined water rising zone is configured to predict the height of the confined water rising zone.

2. The method for predicting a height of a confined water rising zone according to claim 1, wherein a process of calculating a degree of correlation between the height of the confined water rising zone and the correlation factor value sequence using a GRA method for the height of any confined water rising zone and any correlation factor value sequence in the training sample comprises:
performing dimensionless processing on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone;
calculating an absolute difference between the standardized correlation factor value sequence and the standardized height of the confined water rising zone;
obtaining a correlation coefficient between the height of the confined water rising zone and the correlation factor value sequences according to the absolute difference; and
calculating the degree of correlation between the height of the confined water rising zone and the correlation factor value sequences according to the correlation coefficient.

3. The method for predicting a height of a confined water rising zone according to claim 2, wherein a process of performing dimensionless processing on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone comprises:
calculating an average value of the multiple correlation factor value sequences and an average value of the heights of the multiple confined water rising zones in the training sample according to the multiple correlation factor value sequences and the heights of the multiple confined water rising zones in the training sample;
obtaining a standard deviation of the multiple correlation factor value sequences and a standard deviation of the heights of the multiple confined water rising zones in the training sample according to the average value of the multiple correlation factor value sequences, the average value of the heights of the multiple confined water rising zones, and the multiple correlation factor value sequences and the heights of the multiple confined water rising zones in the training sample; and
standardizing the correlation factor value sequence and the height of the confined water rising zone according to the average value of the multiple correlation factor value sequences, the average value of the heights of the multiple confined water rising zones, the standard deviation of the multiple correlation factor value sequences, and the standard deviation of the heights of the multiple confined water rising zones in the training sample for the height of any confined water rising zone and any correlation factor value sequence in the training sample to obtain the standardized correlation factor value sequence and the standardized height of the confined water rising zone.

4. The method for predicting a height of a confined water rising zone according to claim 1, wherein a process of obtaining a height prediction model of a confined water rising zone based on PCA-PSO-SVR, the value of each indicator in the indicator system corresponding to the height of each of the multiple confined water rising zones in the training sample, and the test sample comprises:
calculating a weight of each indicator using PCA according to the value of each indicator in the indicator system corresponding to the height of each of the multiple confined water rising zones in the training sample;
weighting the value of each indicator in the indicator system corresponding to the height of the confined water rising zone according to the weight of each indicator for the height of any confined water rising zone in the training sample to obtain a weighted indicator; and
obtaining the height prediction model of a confined water rising zone using PSO-SVR according to the weighted indicator and the test sample.

5. The method for predicting a height of a confined water rising zone according to claim 4, wherein a process of obtaining the height prediction model of a confined water rising zone using PSO-SVR according to the weighted indicator and the test sample comprises:
initializing a particle swarm, wherein the particle swarm comprises multiple groups of parameters of an SVR model, and each group of parameters comprises a penalty factor coefficient and a kernel function;
substituting the weighted indicator into an SVR model corresponding to each group of parameters to obtain fitness of the SVR model corresponding to each group of parameters; and
determining whether a target model is an optimal target model according to the test sample to obtain a first determination result, wherein the target model is an SVR model corresponding to a parameter with maximum fitness; and
responsive to determining that the target model is an optimal target model according to the test sample, determining that the target model is the height prediction model of a confined water rising zone; and
responsive to determining that the target model is not an optimal target model according to the test sample, updating the particle swarm and substituting the weighted indicator into an SVR model corresponding to each group of parameters to obtain fitness of the SVR model corresponding to each group of parameters of the updated particle swarm.

6. A system for predicting a height of a confined water rising zone, comprising:
an obtaining module configured to obtain sample data, wherein the sample data comprises heights of multiple confined water rising zones and multiple correlation factor value sequences; each of the multiple correlation factor value sequences comprising values of a same correlation factor of all of the multiple confined water rising zones; and correlation factors comprise a mining depth of a coal seam, a unit water inflow exposed by a confined floor, a thickness of an aquifer, a permeability coefficient of the confined floor, a slope length of a working face, an advancing speed, a mining height, a damage variable of a coal seam floor, a fault strength index, a fault fractal dimension, a pressure of floor confined water, a liquid surface tension coefficient, a fracture coefficient, and a density of floor aquifer water;
a training sample and test sample generation module configured to divide the sample data into a training sample and a test sample;
a correlation degree calculation module configured to calculate a degree of correlation between the height of a confined water rising zone of the multiple confined water rising zones and a correlation factor value sequence of the multiple correlation factor value sequences using a grey relational analysis (GRA) method for the height of any confined water rising zone and any correlation factor value sequence in the training sample;
a correlation factor screening module configured to screen the correlation factors according to the degree of correlation between the height of each of the multiple confined water rising zones and each of the multiple correlation factor value sequences to obtain screened correlation factors;
a weight calculation module configured to calculate weights of the screened correlation factors using an entropy weight method (EWM);
a standardizing module configured to perform dimensionless processing on correlation factor value sequences corresponding to the screened correlation factors using a fuzzy comprehensive evaluation method to obtain standardized screened correlation factor value sequences;
an indicator calculation module configured to determine an indicator system according to the screened correlation factors, and calculate a value of each indicator in the indicator system corresponding to the height of each of the multiple confined water rising zones in the training sample according to the standardized screened correlation factor value sequences and the weights of the screened correlation factors; and
a module for determining a height prediction model of a confined water rising zone configured to obtain a height prediction model of a confined water rising zone based on principal component analysis (PCA)-particle swarm optimization (PSO)-support vector regression (SVR), the value of each indicator in the indicator system corresponding to the height of each of the multiple confined water rising zones in the training sample, and the test sample, wherein the height prediction model of a confined water rising zone is configured to predict the height of the confined water rising zone.

7. The system for predicting a height of a confined water rising zone according to claim 6, wherein the correlation degree calculation module comprises:
a standardizing unit configured to perform dimensionless processing on the height of the confined water rising zone and the correlation factor value sequence using the fuzzy comprehensive evaluation method for the height of any confined water rising zone and any correlation factor value sequence in the training sample to obtain a standardized correlation factor value sequence and a standardized height of the confined water rising zone;
an absolute difference calculation unit configured to calculate an absolute difference between the standardized correlation factor value sequence and the standardized height of the confined water rising zone;
a correlation coefficient calculation unit configured to obtain a correlation coefficient between the height of the confined water rising zone and the correlation factor value sequences according to the absolute difference; and
a correlation degree calculation unit configured to calculate the degree of correlation between the height of the confined water rising zone and the correlation factor value sequences according to the correlation coefficient.

8. The system for predicting a height of a confined water rising zone according to claim 7, wherein the standardizing unit comprises:
an average value calculation subunit configured to calculate an average value of the correlation factor value sequences and an average value of the heights of the multiple confined water rising zones in the training sample according to the correlation factor value sequences and the heights of the multiple confined water rising zones in the training sample;
a standard deviation calculation subunit configured to obtain a standard deviation of the correlation factor value sequences and a standard deviation of the heights of the multiple confined water rising zones in the training sample according to the average value of the correlation factor value sequences, the average value of the heights of the multiple confined water rising zones, and the correlation factor value sequences and the heights of the multiple confined water rising zones in the training sample; and
a standardizing subunit configured to standardize the correlation factor value sequences and the height of the confined water rising zone according to the average value of the correlation factor value sequences, the average value of the heights of the multiple confined water rising zones, the standard deviation of the correlation factor value sequences, and the standard deviation of the heights of the multiple confined water rising zones in the training sample for the height of any confined water rising zone and any correlation factor value sequence in the training sample to obtain the standardized correlation factor value sequence and the standardized height of the confined water rising zone.

9. The system for predicting a height of a confined water rising zone according to claim 6, wherein the module for determining a height prediction model of a confined water rising zone comprises:
a weight calculation unit configured to calculate a weight of each indicator using PCA according to the value of each indicator in the indicator system corresponding to the height of each of the multiple confined water rising zones in the training sample;
a weighting unit configured to weight the value of each indicator in the indicator system corresponding to the height of the confined water rising zone according to the weight of each indicator for the height of any confined water rising zone in the training sample to obtain a weighted indicator; and
a unit for determining a height prediction model of a confined water rising zone configured to obtain the height prediction model of a confined water rising zone using PSO-SVR according to the weighted indicator and the test sample.

10. The system for predicting a height of a confined water rising zone according to claim 9, wherein the unit for determining a height prediction model of a confined water rising zone comprises:
an initializing subunit configured to initialize a particle swarm, wherein the particle swarm comprises multiple groups of parameters of an SVR model, and each group of parameters comprises a penalty factor coefficient and a kernel function;
a fitness calculation subunit configured to substitute the weighted indicator into an SVR model corresponding to each group of parameters to obtain fitness of the SVR model corresponding to each group of parameters;
a determination subunit configured to determine whether a target model is an optimal target model according to the test sample to obtain a first determination result, wherein the target model is an SVR model corresponding to a parameter with maximum fitness;
a first result determination subunit configured to determine that the target model is the height prediction model of a confined water rising zone responsive to a determination that the target model is an optimal target model according to the test sample; and
a second result determination subunit configured to update the particle swarm and substitute the weighted indicator into an SVR model corresponding to each group of parameters to obtain fitness of the SVR model corresponding to each group of parameters of the updated particle swarm responsive to a determination that the target model is not an optimal target model according to the test sample.
